(19) United States
(12) Patent Application Publication
(10) Pub. No.: US 2025/0386885 A1
(43) Pub. Date: Dec. 25, 2025

(54) ALL PURPOSE MITTEN

(71) Applicant: Douglas James Walsh, Ocala, FL (US)

(72) Inventor: Douglas James Walsh, Ocala, FL (US)

(21) Appl. No.: 19/248,035

(22) Filed: Jun. 24, 2025

Related U.S. Application Data
(60) Provisional application No. 63/663,554, filed on Jun. 24, 2024.

(51) Int. Cl. A41D 19/01; A41D 19/00; A62B 17/00

(52) U.S. Cl. CPC A41D 19/01; A41D 19/0006; A62B 17/006

(57) ABSTRACT

The present invention provides an innovative mitten for people working outside handling chemicals, solvents, or dirty materials in liquid form. The main body of the mitten comprises two layers including an outer layer made of polyester microfibers and an inner layer made of rubberized material, such as a polyurethane foam. The polyurethane foam has a mixture of open and closed cells, creating a waterproof membrane. The microfiber material in the outer layer of the mitten has a moisture wicking rubberized material adhered to the inside keeping water, oil, conditioner, wax, detailers, tire shines and any other non-flammable liquids off your hands.

### FIELD OF THE PRESENT INVENTION

The present invention relates generally to mittens. More specifically, the present invention relates to an all-purpose mitten worn by workers working outside, such as automotive workers, handling chemicals, solvents, detergents, or other dirty materials in liquid form.

### BACKGROUND OF THE PRESENT INVENTION

Mittens are widely worn by people protecting against cold and severe climate. For people working outside, the mittens may often be in contact with solvents, chemicals, and other dirty materials. There is a need of mittens that have an ability to apply the product to the mitten without it soaking through on to your hands. Conventional mittens in the markets are not suitable for such purpose. It is an objective of the present invention to address this issue by providing people with an all-purpose mitten to keep their hands clean and free of contamination from the external environment.

### BRIEF DESCRIPTION OF THE DRAWINGS

The all-purpose mitten is the disclosure herein of an exemplary embodiment of the present invention. The forgoing and other features and advantages of the present invention will become more apparent from the following detailed description taken in conjunction with the accompanying drawings.

FIG. 1 is a front view of the mitten according to the embodiment of the present invention.

FIG. 2 is a front view of the mitten with a section of the seam opened and one corner folded up for exposing inner layer of the mitten according to the embodiment of the present invention.

FIG. 3 is a photo showing front view of the mitten according to the embodiment of the present invention.

FIG. 4 is a photo of the mitten with a bottom section folded up to expose inner layer of the mitten according to the embodiment of the present invention.

### DETAILED DESCRIPTIONS OF THE INVENTION

All illustrations of the drawings are for the purpose of describing selected versions of the present invention and are not intended to limit the scope of the present invention.

Reference will be made in detail to an exemplary embodiment of the invention, which is illustrated in the accompanying drawings. Wherever possible, the same reference numbers will be used throughout the drawings to refer to the same or like parts.

The present invention works on an all-purpose mitten to keep the people's hands clean and free of contamination when working outside handling chemicals, solvents, or other dirty materials in liquid form. The mitten is suitable for automotive technicians cleaning, conditioning, and applying products to enhance interiors of vehicles, exteriors of automobiles, motorcycles, and boats. The mitten also has a market for equestrian care as well as leather care.

The mitten is composed of two layers including an outer layer and an inner layer for providing two functions. A microfiber outer layer holds conditioner, chemicals, or detergent to waste less while a rubber material inner layer allows user's hands dry and free of chemicals during a chemical application process.

Although the invention has been explained in relation to its preferred embodiment, it is to be understood that many other possible modifications and variations can be made without departing from the spirit and scope of the invention.

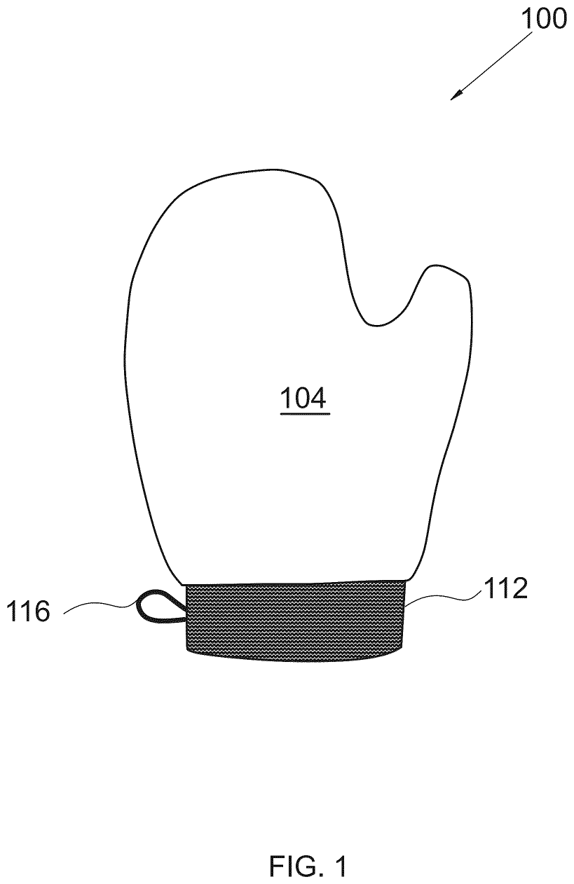

Referring to FIG. 1, there illustrated is a front view of a mitten 100 according to the embodiment of the present invention. The main body of the mitten 100 is made of two layers. An outer layer 104 is composed of microfiber material, such as a polyester. The microfiber material has a moisture adsorbing property. An elastic band 112 about 1 inch in width is double stitched to the main body of mitten 100 to enclose wrist of a user. A small loop 116 is attached to the elastic band 112 for easy mitten pickup.

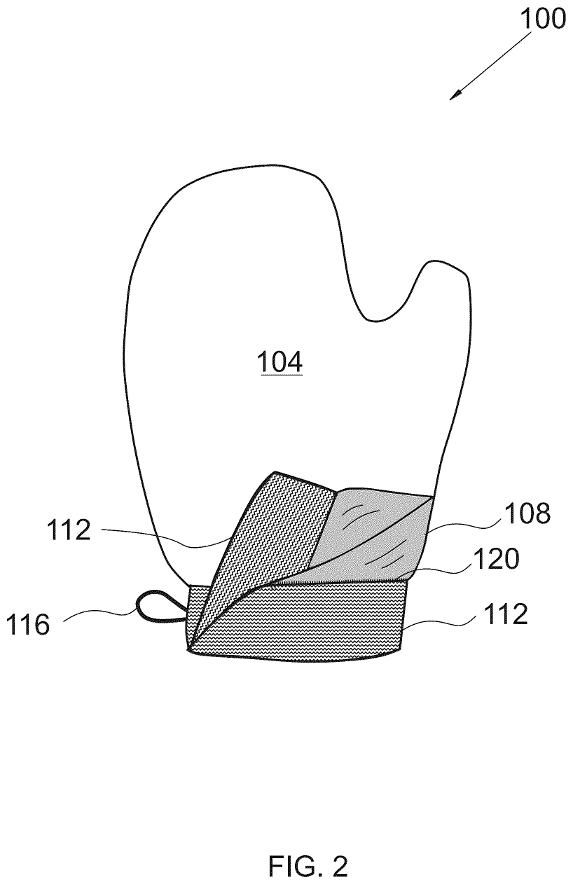

Referring to FIG. 2, there illustrated is a front view of the mitten 100 with a section of the seam opened and one corner folded up to expose inner layer 108 of the mitten 100 according to the embodiment of the present invention. In FIG. 2, the inner layer 108 is made of a rubber material, such as polyurethane foam, which has a mixture of open and closed cells. As a result, the inner layer 108 functions as a synthetic sponge with a moisture wicking barrier film. The mitten has a layer of moisture membrane, which is waterproof and chemical resistant. A combination of the inner 108 and outer 104 layers accomplishes water/chemical impermeability.

Referring to FIG. 2 again, the inner layer 108 is bound to the outer layer 104 by an adhesive, such as a contact cement. Thus, microfiber material in the outer layer 104 has a moisture wicking rubberized material adhered to the inside keeping water, oil, conditioner, wax, detailers, tire shines and any other non-flammable liquids off your hands.

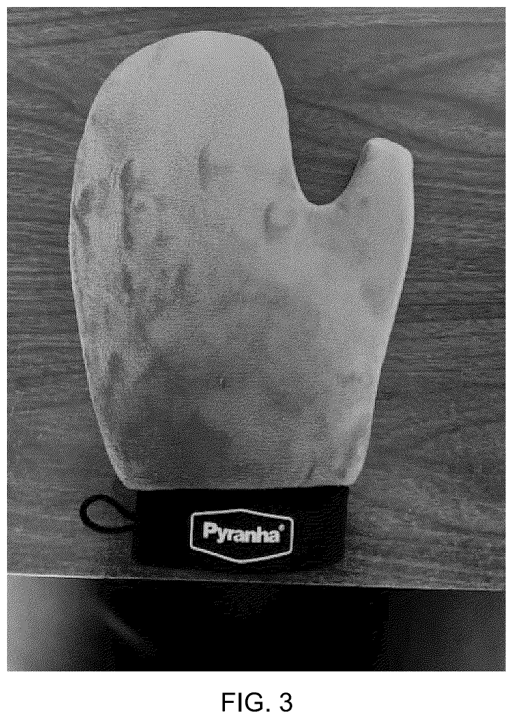

Referring to FIG. 3, there illustrated is a photo showing front view of the mitten 100 according to the embodiment of the present invention. As shown, the outer layer 104, which is made of polyester microfiber, is blue color with a fluffy feel. The elastic band 112 in black color is attached to the outer layer 104.

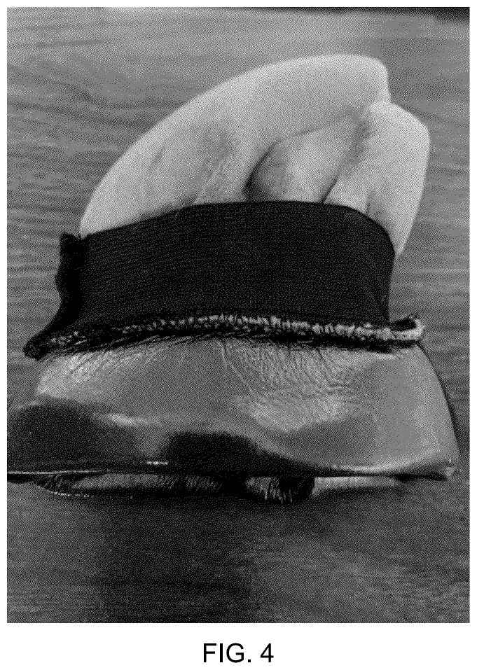

Referring to FIG. 4, there illustrated is a photo of the mitten 100 with a bottom section folded up to expose inner layer 108 of the mitten according to the embodiment of the present invention. The inner layer 108, which is made of polyurethane, has a shiny brown color. As shown in FIG. 4, the seam 120 shows the fiber ends of inner layer 108, outer layer 104, and elastic band 112. Thus, the three layers including the inner and outer layers, and the elastic band are double stitched, leading to the stitch line 120 using a spun polyester thread.

The present invention has been described in terms of exemplary embodiment solely for the purpose of illustration. Persons skilled in the art will recognize from this description that the invention is not limited to the embodiment described but may be practiced with modifications and alterations.

1. A utility mitten comprising:
two or more layers of material formed into a mitten shape relatively close to the silhouette of a closed hand;
wherein
an outermost layer completely envelopes all other layers;
an innermost layer is shaped to completely envelope a user's hand up to their wrist while worn and in use;
the outermost layer comprises a material absorbent of liquids; and
the innermost layer comprises a material impermeable to one or more liquids.

2. The mitten of claim 1, wherein the outermost layer comprises absorbent microfiber materials.

3. The mitten of claim 1, wherein the innermost layer comprises foam rubber materials.
